(19) United States
(12) Patent Application Publication
(10) Pub. No.: US 2009/0135833 A1
(43) Pub. Date: May 28, 2009

(54) Ingress node and egress node with improved packet transfer rate on multi-protocol label switching (MPLS) network, and method of improving packet transfer rate in MPLS network system

(76) Inventors: Won-kyoung Lee, Daejeon-si (KR); Jae-woo Park, Daejeon-si (KR); Bheom-soon Joo, Daejeon-si (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/156,331

(22) Filed: May 30, 2008

(30) Foreign Application Priority Data
Nov. 26, 2007 (KR) 10-2007-0121110

(51) Int. Cl. H04L 12/56

(52) U.S. Cl. 370/395.53

(57) ABSTRACT

Provided are an ingress node and an egress node on a Multi-Protocol Label Switching (MPLS) network, with an improved packet transfer rate, and a packet transfer rate improving method in a MPLS network system. By assigning a MPLS label to a destination MAC address of a packet in order to guarantee Quality of Service (QoS), it is possible to distributively transmit packets through a variety of paths on a MPLS network and thus improve a packet transfer rate.

### CROSS REFERENCE TO RELATED APPLICATIONS

This application claims priority from Korean Patent Application No. 10-2007-0121110, filed on Nov. 26, 2007, the disclosure of which is incorporated herein in its entirety by reference.

### BACKGROUND OF THE INVENTION

1. Field of the Invention

The present invention relates to an ingress node and an egress node on a Multi-Protocol Label Switching (MPLS) network, which have an improved packet transfer rate, and a method of improving a packet transfer rate in a MPLS network system, and more particularly, to a technique of constructing a lookup table for a packet forwarding between a Layer 2 network and a Multi-Protocol Label Switching (MPLS) network, and a packet forwarding algorithm.

This work was partly supported by the IT R&D program of MIC/IITA [2005-S-102-03, Carrier Class Ethernet Technology].

2. Description of the Related Art

A Layer 2 network includes a network through which a packet is transmitted after Virtual Local Area Network (VLAN) tag is appended to the header of the packet in order to guarantee Quality of Service (QoS), and a network through which a packet is transmitted after only an Ethernet header is appended to the packet without the VLAN tag. Meanwhile, in a Layer 3 network, a routing table is looked up using an IP address.

As illustrated in FIG. 1, when Layer 2 networks (VLAN networks) and Layer 3 networks (IP networks) are connected to a Multi-Protocol Label Switching (MPLS) network, a switch apparatus at an Ingres node through which packets are transmitted from a Layer 2 or Layer 3 network to the MPLS network appends MPLS labels to the headers of the packets and then transmits the resultant packets to the MPLS network, and a switch apparatus at an egress node through which packets are transmitted from the MPLS network to a Layer 2 or Layer 3 network removes MPLS labels from the headers of the packets and then transmits the resultant packets to destination ports.

In the point-to-point case of a Layer 2 or Layer 3 network which does not support the VLAN, a lookup key for searching for a MPLS label of a packet is a port number through which the packet is input. For example, all packets received through port 1 are appended a MPLS label of “100” and transmitted to port 2.

Also, in a Layer 2 network which supports the VLAN, since MPLS labels are one-to-one mapped to VLAN IDs, packets having the same VLAN ID have the same MPLS label and are transmitted to the same port. Accordingly, the more entries having the same VLAN ID, the more load on a path, which lowers a packet transfer rate on the network so that QoS, etc. cannot be guaranteed.

### SUMMARY OF THE INVENTION

The present applicant has carried out a study on a technique for improving a packet transfer rate, by assigning Multi-Protocol Label Switching (MPLS) labels to destination Media Access Control (MAC) addresses of packets to distributively transmit the packets through various paths on a MPLS network, while maintaining information about a Virtual Local Area Network (VLAN).

The present invention provides an ingress node and an egress node of a MPLS network, which are capable of improving a packet transfer rate by assigning MPLS labels respectively to destination MAC addresses of packets to thus distributively transmit the packets through various paths on the MPLS network, and a method of improving a packet transfer rate in a MPLS network system.

According to an aspect of the present invention, there is provided an ingress node of a Multi-Protocol Label Switching (MPLS) network, the ingress node including a Virtual Local Area Network (VLAN) table for establishing a VRAN, an L2 port table for port mapping, a VLAN port table for mapping the VLAN table to the L2 port table, a forwarding database table for setting a path, and a packet processor for setting a path using the tables and forwarding a packet, the ingress node including: a label (NHLFE) table storing MPLS label information for each destination MAC address; and a label index table for mapping the VLAN table to the label table, wherein the VLAN table comprises a label index table address field for accessing the label index table.

According to another aspect of the present invention, there is provided an egress node of a Multi-Protocol Label Switching (MPLS) network, including: an incoming label map (ILM) table storing information for processing a MPLS label, and address information of a Virtual Local Area Network (VLAN) table; an ILM index table in which each ILM table is stored as an index value corresponding to the MPLS label; and a packet processor searching for an ILM table corresponding to a MPLS label included in the received packet from the ILM index table, searching for an output port using a VLAN table corresponding to VLAN table address information included in the searched ILM table, removing MPLS label information from the received packet, and outputting the resultant packet through the output port.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 shows a MPLS network to which Layer 2 networks (VLAN networks) and Layer 3 networks (IP networks) are connected;

FIG. 2 is a view for explaining a case where an IP packet received from a Layer 3 network is processed by a MPLS network and transmitted to another Layer 3 network;

FIG. 3 shows a format of the IP packet illustrated in FIG. 2;

FIG. 4 is a view for explaining a case where a packet received from a VLAN-aware Layer 2 network is processed by a MPLS network and transmitted to another VLAN-aware Layer 2 network;

FIG. 5 is a view for explaining a case where a packet received from a VLAN-unaware Layer 2 network is processed by a MPLS network and transmitted to another VLAN-unaware Layer 2 network;

FIG. 6 is a view for explaining a case where a packet received from a VLAN-aware Layer 2 network is processed by a MPLS network and transmitted to a VLAN-unaware Layer 2 network;

FIG. 7 is a view for explaining a case where a packet received from a VLAN-unaware Layer 2 network is processed by a MPLS network and transmitted to a VLAN-aware Layer 2 network;

FIG. 8 shows a format of a packet which is transmitted on a VLAN network;

FIG. 9 shows a format of a MPLS label;

FIG. 10 is a block diagram of an ingress node with an improved packet transfer rate on a MPLS network, according to an embodiment of the present invention;

FIG. 11 is a general view of the data structures used in the ingress node on the MPLS network illustrated in FIG. 10, according to an embodiment of the present invention;

FIG. 12 is the forwarding algorithm of a packet transfer rate improving method which is performed by the ingress node on the MPLS network illustrated in FIG. 10, according to an embodiment of the present invention;

FIG. 13 is a block diagram of an egress node on a MPLS network, with an improved packet transfer rate, according to an embodiment of the present invention;

FIG. 14 is a general view of the data structures used in the egress node on the MPLS network illustrated in FIG. 13, according to an embodiment of the present invention; and

FIG. 15 is the forwarding algorithm of a packet transfer rate improving method which is performed by the egress node on the MPLS network illustrated in FIG. 13, according to an embodiment of the present invention.

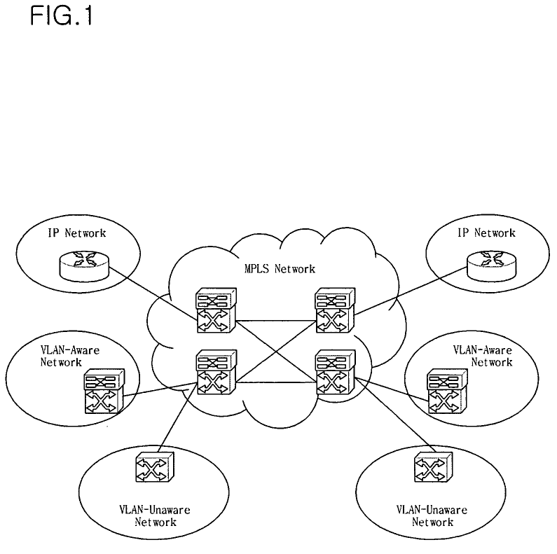

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

In an ingress node or an egress node according to the present invention, by assigning Multi-Protocol Label Switching (MPLS) labels respectively to destination MAC addresses of packets to distributively transmit the packets through various paths on a MPLS network, a packet transfer rate can be improved.

Further, since the ingress node or the egress node can append a VLAN tag to or remove it from a packet according to whether an apparatus connected thereto supports a VLAN, the ingress node or the egress node can be used for general purposes.

Also, since an Incoming Label Map (ILM) table is looked up using an index value assigned according to a MPLS label, instead of using a MPLS label, a table look-up is possible regardless of a memory size.

Hereinafter, embodiments of the present invention will be described in detail with reference to the appended drawings.

Possible cases where a Layer 3 network (an IP network), a Layer 2 network (a VLAN network), and a MPLS network are connected with one another to transmit and receive packets therebetween are as follows:

1) Layer 3→MPLS→Layer 3

2) VLAN-aware Layer 2→MPLS→VLAN-aware Layer 2

3) VLAN-unaware Layer 2→MPLS→VLAN-unaware Layer 2

4) VLAN-aware Layer 2→MPLS→VLAN-unaware Layer 2

5) VLAN-unaware Layer 2→MPLS→VLAN-aware Layer 2

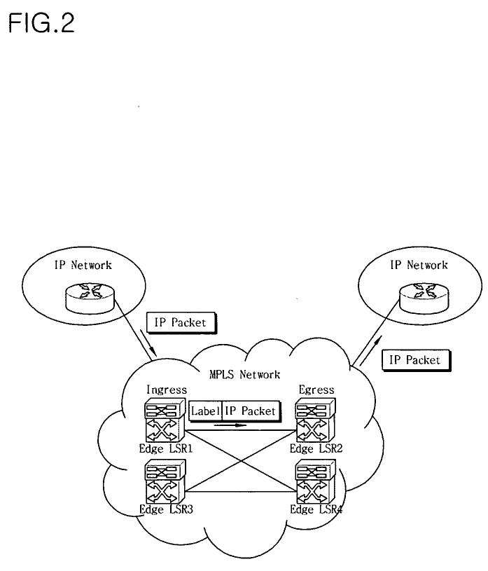

As illustrated in FIG. 2, in the case (1), an ingress node of a MPLS network receives an IP packet from an IP network, appends a MPLS label to the IP packet, and then transfers the MPLS packet to an egress node of the MPLS network, and the egress node removes the MPLS label from the MPLS packet and then transmits the resultant IP packet to another IP network.

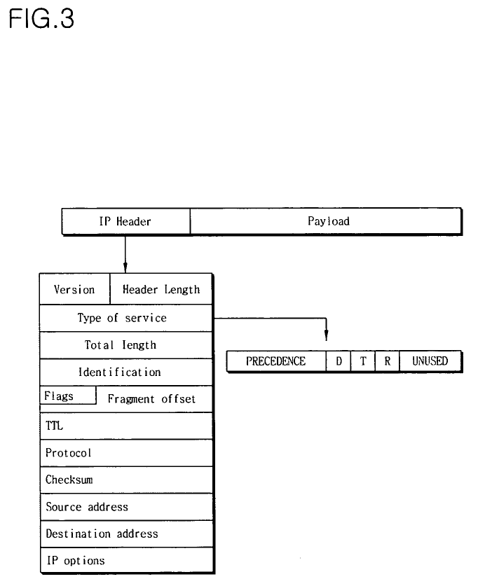

An exemplary format of the IP packet is illustrated in FIG. 3. The IP header of the IP packet includes a plurality of fields, which will be described below.

A Version field stores version information of an IP protocol. A Total Length field stores information about a total length of a datagram including all the header and payload of the IP packet. A Type of service field stores information about how the packet is processed, wherein “PRECEDENCE” represents significance of the datagram, “D” represents a field set when a small delay is required, “T” is a field set when a large amount of processing is required, and “R” is a field set when high reliability is required. If the packet has a size larger than a maximum transmission unit (MTU), the packet is fragmented. Fields used for fragmentation are Identification, Fragment offset, and Flags fields.

A TTL (Time To Live) field stores information about a time during which a single datagram can be maintained on the Internet.

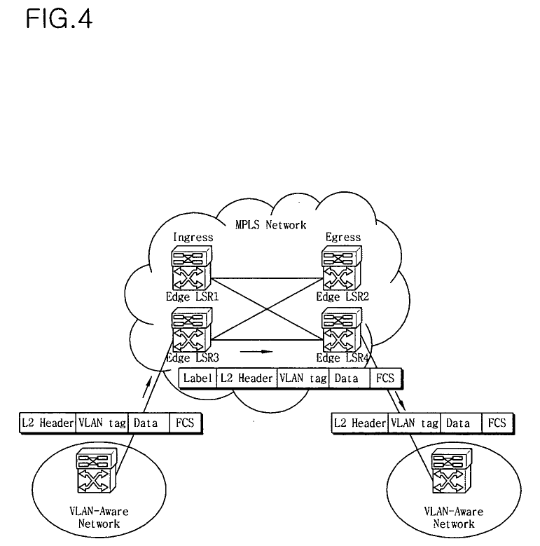

As illustrated in FIG. 4, in the case (2), an ingress node of a MPLS network receives a Layer 2 packet with a VLAN tag from a VLAN-aware network, appends a MPLS label to the Layer 2 packet, and then transmits the MPLS packet to an egress node of the MPLS, and the egress node removes the MPLS label from the MPLS packet.

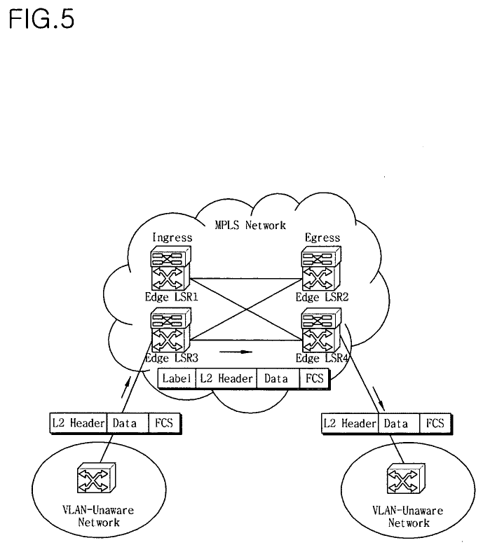

As illustrated in FIG. 5, the case (3) is a case where an untagged packet is transmitted. In the case (3), an ingress node of a MPLS network appends a MPLS label to the Layer 2 packet and transmits the MPLS packet to an egress node of the MPLS network, and the egress node removes the MPLS label from the MPLS packet.

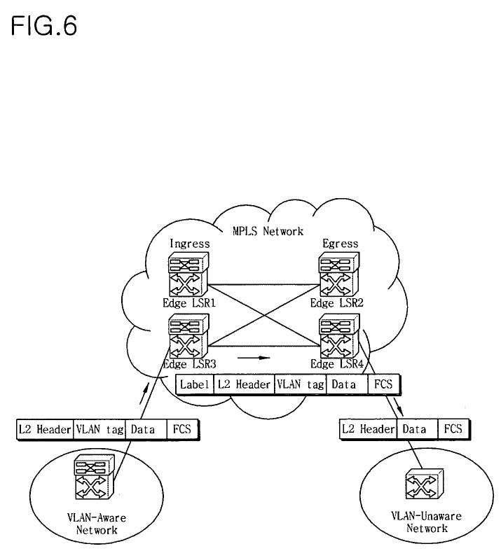

As illustrated in FIG. 6, in the case (4), an ingress node of a MPLS network receives a Layer 2 packet with a VLAN tag from a VLAN-aware network, appends a MPLS label to the Layer 2 packet, and then transmits the MPLS packet to an egress node of the MPLS network, and the egress node removes the MPLS label and VLAN tag from the MPLS packet.

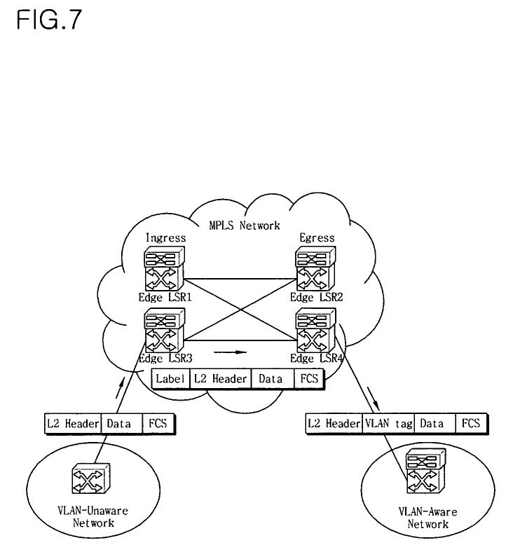

As illustrated in FIG. 7, unlike the case (4), in the case (5), an ingress node of a MPLS network receives an untagged Layer 2 packet from a VLAN-unaware network, appends a VLAN tag and a MPLS label to the packet, and then transmits the MPLS packet to an egress node of the MPLS network, and the egress node removes the MPLS label from the MPLS packet.

That is, like the cases (1), (2), and (3), when the same type of networks are connected to the ingress node and egress node, only a function of appending/removing a MPLS label to/from a packet is needed, but, like the cases (4) and (5), when different types of networks are connected to the ingress node and egress node, a function of appending/removing a VLAN tag to/from a packet is also needed along with a function of appending/removing a MPLS label to/from a packet.

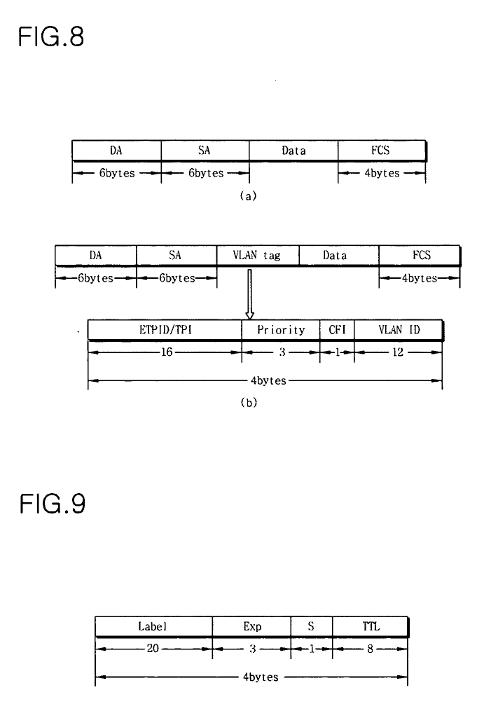

FIG. 8 shows a format (a) of an untagged packet, and a format (b) of a packet with a VLAN tag. The VLAN tag is inserted following a SA field, and includes four fields. In the VLAN tag, an ETPID/TPI field stores an Ethernet-extended Tag Protocol ID, and Priority consists of 3 bits and can be set to 8 levels. A CFI (Canonical Formal Identifier) field is 1 bit. If the CFI field is set to “1”, this means that a Token-Ring frame is capsulated in a tagged Ethernet frame.

FIG. 9 shows a format of a MPLS label. In the format of the MPLS label, an Exp field is used to implement differentiated services (DiffServ), and an S field is set to “1” when the MPLS label is a bottom label of a label stack, that is, when the MPLS label is a final entry.

Communications between a Layer 3 network and a MPLS network, as illustrated in the case (1), are well-known in the art, and therefore a detailed description thereof will be omitted. Accordingly, in this specification, only a technique (the cases (2) through (5)) for communications between a Layer 2 network and a MPLS network will be described.

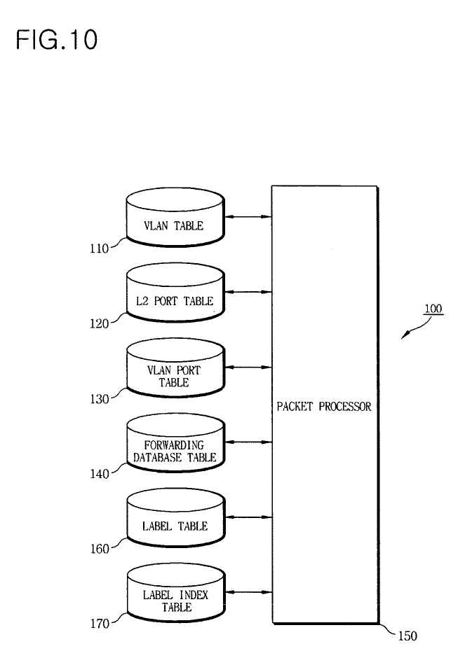

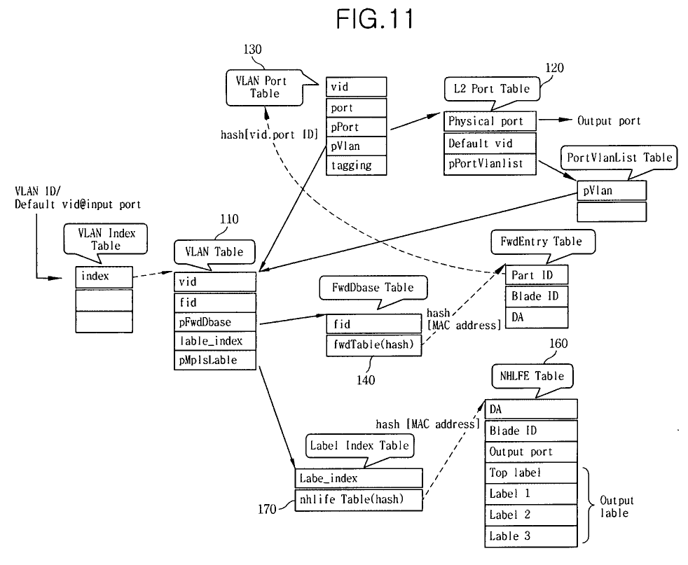

FIG. 10 is a block diagram of an ingress node 100 with an improved packet transfer rate on a MPLS network, according to an embodiment of the present invention, and FIG. 11 is a general view of the data structures used in the ingress node on the MPLS network illustrated in FIG. 10, according to an embodiment of the present invention. As illustrated in FIGS. 10 and 11, the ingress node 100 with the improved packet transfer rate includes a VLAN table 110, an L2 port table 120, a VLAN port table 130, a forwarding database (FwdDbase) table 140, and a packet processor 150. The ingress node 100 further includes a label table 160 and a label index table 170 that are main components for achieving an object of the present invention. The VLAN table 110 includes the address field of the label index table for accessing the label index table 170.

The VLAN table 110 is used to establish a VLAN, and includes a vid field in which a VLAN ID is stored, a fid field in which an index value of the FwdDbase table 140 is stored, a pFwdDbase field in which an address of the FwdDbase table 140 is stored, a label_index field in which an index value of the label index table 170 is stored, and a pMplsLabel field in which an address of the label index table 170 is stored.

The L2 port table 120 is used for port mapping, and includes a physical port field in which a value of a physical output port is stored, a Default vid field in which a default VLAN ID is stored, etc.

The VLAN port table 130 is used to map the VLAN table 110 to the L2 port table 120, and includes a vid field in which a VLAN ID is stored, a port field in which an index value of the L2 port table 120 is stored, a pPort field in which an address of the L2 port table 120 is stored, a pVlan field in which an address of the VLAN table 110 is stored, a tagging field in which information for determining whether to append a VLAN tag to the corresponding packet is stored, etc.

The FwdDbase table 140 is used for path setting, and includes a fid field in which an index value of the FwdDbase table 140 is stored, a fwdTable field in which a hash value of a MAC address for searching for a FwdEntry table is stored, etc.

The packet processor 150 searches for the VLAN table 110, the L2 port table 120, the VLAN port table 130, the FwdDbase table 140, etc., determines a port through which the packet is to be transmitted, sets a path, and forwards the packet.

The label (NHLFT) table 160 is used to store MPLS label information for destination MAC addresses, and includes a destination address (DA) field storing index information which is a hash value of a destination MAC address to which the packet is to be transmitted, a Blade ID field in which a line card number for transmitting the packet is stored, an output port field in which an output port value is stored, Top label, Label 1, Label 2, and Label 3 fields in which MPLS label information is stored, etc.

The label index table 170 is used to map the VLAN table 110 to the NHLFE table 160, and includes a label_index field in which an index value of the label index table 170 is stored, a NHLFE Table field in which a hash value of a MAC address for accessing the label table 160 is stored, etc.

In the ingress node with the improved packet transfer rate on the MPLS network, the packet processor 150 adds MPLS label information looked up from the label table (NHLFE table) 160 to the header of the packet, and transmits the resultant packet to the searched output port. A VLAN tag can be included in the packet according to a value of the tagging field of the VLAN port table 130. The packet processor 150 searches for the VLAN table 110 using a VLAN ID in order to searching for the address of the corresponding label index table. If a VLAN ID is included in the packet, the packet processor 150 determines the VLAN ID as a VLAN ID, and if no VLAN ID is included in the packet, the packet processor 150 determines as a VLAN ID a default VLAN ID set in the L2 port table 120 corresponding to the input port.

The packet processor 150 searches for the label index table 170 with reference to the pMplsLabel field in which the address of the label index table is stored, acquires MPLS label information from the label table 160 with reference to the NHLFE Table field in which the hash value of the destination MAC address for accessing a label table of the searched label index table 170 is stored, thereby adding the MPLS label information to the header of the packet.

Accordingly, since the MPLS label information is acquired from the label table 160, packets can be distributively transmitted through a variety of paths. Also, since table indexing is performed using a hash value of a destination MAC address, a time consumed to look up a table can be shortened. Furthermore, since a VLAN tag is inserted into or removed from a packet according to a tagging field value of a VLAN port table, operation flexibility can be achieved according to whether a VLAN is supported.

Meanwhile, in order to search for an output port, the packet processor 150 searches for a VLAN table 110 corresponding to the VLAN ID, acquires a line card number (a Blade ID of a FwdEntry Table in FIG. 11) and an output port ID (a Port ID of a FwdEntry Table in FIG. 11) from a FwdDbase Table 140 linked to the VLAN table 110, and acquires output port (a Physical port of an L2 Port Table in FIG. 11) information from an L2 port table 120 linked to the corresponding VLAN port table 130.

Here, the packet processor 150 acquires the output port ID and the line card number from a FwdEntry Table corresponding to a hash value of a MAC address stored in the fwdTable field of the FwdDbase table 140.

Meanwhile, the packet processor 150 searches for a VLAN port table 130 corresponding to the VLAN ID and the hash value of the output port ID acquired from the FwdEntry table, thus acquiring output port (physical port in FIG. 11) information from an L2 port table 120 linked to the VLAN port table 130.

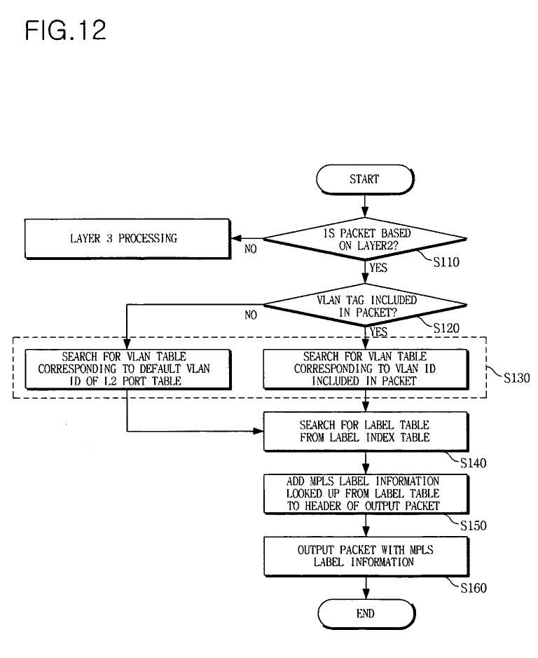

A method of processing MPLS label information, which is performed by the ingress node of the MPLS network as described above, will be described briefly with reference to FIG. 12, below.

If a packet is received, the ingress node of the MPLS network determines whether the received packet is based on a protocol supported in a Layer 3 network (an IP network), or on a protocol supported in a Layer 2 network (a VLAN network) (operation S110).

If the received packet is based on a protocol supported in a Layer 3 network, the ingress node performs Layer 3 processing. Since the Layer 3 processing is beyond the range of the present invention, a detailed description thereof will be omitted.

If the received packet is based on a protocol supported in a Layer 2 network, the ingress node determines whether the packet includes a VLAN tag (operation S120), searches for a VLAN table corresponding to a VLAN ID if the packet includes a VLAN tag, and searches for a VLAN table corresponding to a default VLAN ID of an L2 port table if the packet includes no VLAN tag (operation S130).

Then, the ingress node searches for a label table mapped to the VLAN table and storing MPLS label information for a destination MAC address, from a label index table (operation S140). The ingress node searches for the label index table with reference to a field in which a label index table address of the VLAN table is stored, and acquires MPLS label information from the label table with reference to a field in which a hash value of a destination MAC address for accessing a label table of the searched label index table is stored.

Then, the ingress node adds the MPLS label information looked up from the searched label table to the header of an output packet (operation S150), and outputs the resultant packet through an output port (operation S160). Thus, since the MPLS label information can be obtained from the label table, packets can be distributively transmitted through a variety of paths. Also, since table indexing is performed using a hash value of a destination MAC address, a time consumed to search for a table can be shortened.

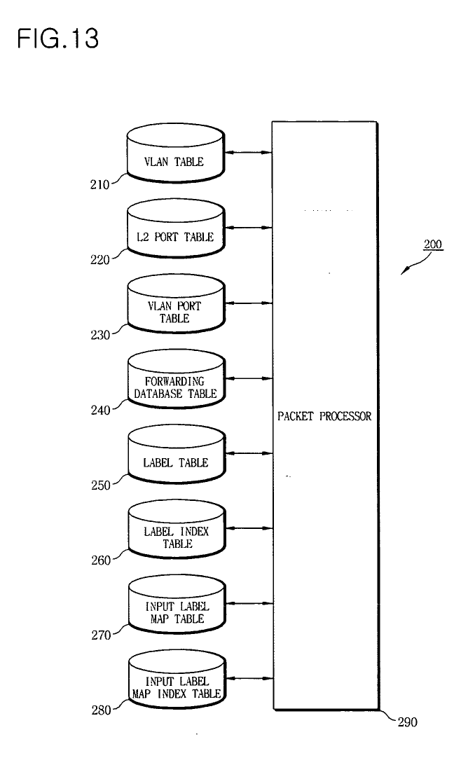

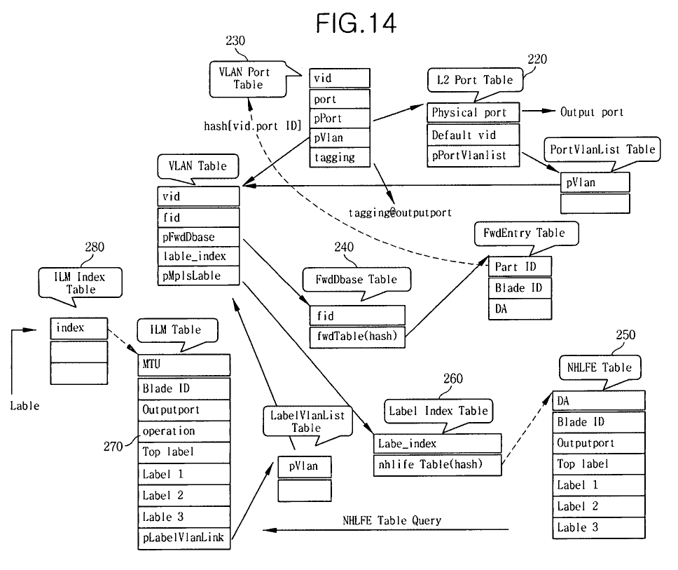

FIG. 13 is a block diagram of an egress node 200 on a MPLS network, with an improved packet transfer rate, according to an embodiment of the present invention. FIG. 14 is a general view of the data structures used in the egress node 200 on the MPLS network illustrated in FIG. 13, according to an embodiment of the present invention. As illustrated in FIGS. 13 and 14, the egress node 200 includes a VLAN table 210, an L2 port table 220, a VLAN port table 230, a forwarding database (FwdDbase) table 240, a label (NHLFE) table 250, and a label index table 260. The characteristics and field configuration of these tables are the same as those of the ingress node 100 described above, and therefore detailed descriptions thereof will be omitted.

The egress node 200 further includes an incoming label map (ILM) table 270, an ILM index table 280, and a packet processor 290, which are main components for achieving the object of the present invention. The ILM table 270 stores information for processing a MPLS label and VLAN table address information, and includes a MTU field storing information about a maximum transmission size of a packet, an operation field storing information about an operating mode, Top level, Label 1, Label 2, and Label 3 fields storing MPLS label information, a pLabelVlanList field storing an address of the VLAN table, etc. The pLabelVlanList field can store information indicating a LabelVlanList table storing an address of a VLAN table to which the corresponding packet belongs.

The operating mode is executed by a label stack, and classified into Swap, Swap & Push, Pop, and Pop & Forward operations. The Swap operation is to replace a top label of the label stack by another label, and the Swap & Push operation is to push at least one label into the label stack after replacing a top label of the label stack by another label. The Pop operation is to remove a top label from the label stack until the label stack is empty. The Pop & Forward operation is to transfer the corresponding packet to a next hop set in an ILM table after removing a top label from a label stack.

In the ILM index table 280, each ILM table is stored as an index value corresponding to a MPLS label.

The packet processor 290 searches for an ILM table 270 corresponding to a MPLS label included in a received packet, from the ILM index table 280, searches for an output port using a VLAN table 210 corresponding to VLAN table address information included in the searched ILM table 270, removes MPLS label information from the received packet, and outputs the resultant packet through the output port.

The packet processor 290 searches for a VLAN table 210 corresponding to a VLAN ID, acquires an output port ID and a line card number from a forwarding database table 240 linked to the VLAN table 210, and acquires output port information from an L2 port table 220 linked to a VLAN port table 230 corresponding to the output port ID and the line card number.

At this time, the packet processing unit 290 acquires the output port ID (a Port ID field in FIG. 14) and the line card number (a Blade ID field in FIG. 14), from a forwarding entry table (a FwdEntry Table) corresponding to a hash value of a MAC address stored in the forwarding entry table field of the forwarding database table 240.

The packet processor 290 searches for a VLAN port table 230 corresponding to the VLAN ID and the hash value of the output port ID acquired from the FwdEntry table, and acquires output port information (a Physical port in FIG. 14) from an L2 port table 230 linked to the VLAN port table 230.

The packet processor 290 outputs the packet from which MPLS label information is removed, through the output port. The packet processor 290 reads a tagging field value from the VLAN port table 230, removes a VLAN tag from the packet or adds a VLAN tag to the packet, according to the tagging field value, and then outputs the resultant packet through the output port.

Accordingly, by searching for an ILM table using an index value, a time consumed to search for a table can be shortened. Also, since a VLAN tag can be added to or removed from a packet according to a tagging field value of a VLAN port table, operation flexibility according to whether a VLAN is supported can be achieved.

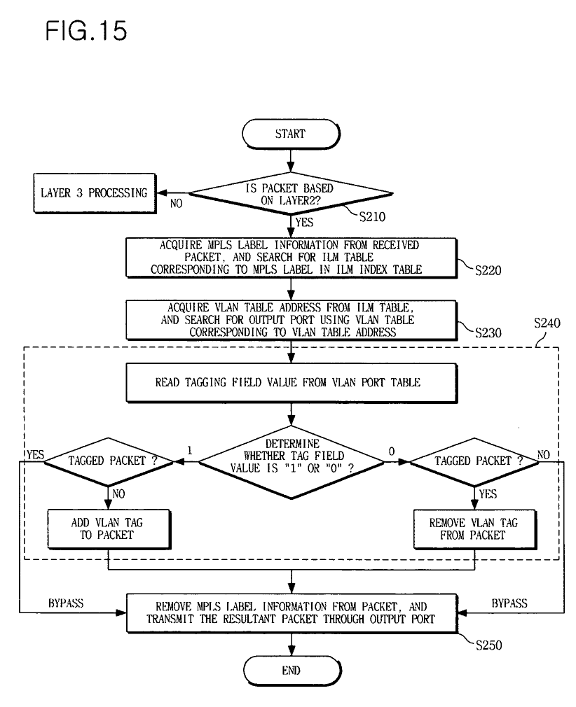

A MPLS label information processing method, which is performed by an egress node with an improved packet transfer rate on a MPLS network, will be described briefly with reference to FIG. 15, below.

If a packet is received from an ingress node, the egress node of the MPLS network determines whether the received packet is based on a protocol supported in a Layer 3 network (an IP network) or on a protocol supported in a Layer 2 network (a VLAN network) (operation S210).

If the packet is based on a Layer 3 protocol, the egress node performs Layer 3 processing. Since the Layer 3 processing is beyond the range of the present invention, in this specification, a detailed description thereof will be omitted.

If the packet is based on a Layer 2 protocol, the egress node acquires MPLS label information from the received packet, and searches for an ILM table corresponding to the MPLS label from an ILM index table (operation S220).

Then, the egress node acquires a VLAN table address from the searched IML table, searches for an output port using a VLAN table corresponding to the VLAN table address (operation S230), reads a tagging field value from the VLAN port table, and removes or adds a VLAN tag from or to the packet according to the tagging field value (operation S240).

If the tagging field value is one, the egress node determines whether a VLAN tag is already included in the packet, and bypasses the packet if a VLAN tag is already included in the packet, and adds a VLAN tag to the packet if no VLAN tag is included in the packet. If the tagging field value is zero, the egress node determines whether a VLAN tag is already included in the packet, and removes the VLAN tag from the packet if the VLAN tag is included in the packet, and bypasses the packet if no VLAN tag is included in the packet.

Finally, the egress node removes MPLS label information from the received packet, and transmits the resultant packet through the output port (operation S250).

Accordingly, by searching for an ILM table using an index value, a time consumed to search for a table can be shortened. Also, since a VLAN tag can be added to or removed from a packet according to a tagging field value of a VLAN port table, operation flexibility according to whether a VLAN is supported can be achieved. The present invention can be applied to configuration of a look up table for communications between a Layer 2 network and a MPLS network, packet forwarding, and applications thereof.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An ingress node of a Multi-Protocol Label Switching (MPLS) network, the ingress node including a Virtual Local Area Network (VLAN) table for establishing a VLAN, an L2 port table for port mapping, a VLAN port table for mapping the VLAN table to the L2 port table, a forwarding database table for setting a path, and a packet processor for setting a path using the tables and forwarding a packet, the ingress node comprising:
a label (NHLFE) table storing MPLS label information for each destination MAC address; and
a label index table for mapping the VLAN table to the label table,
wherein the VLAN table comprises a label index table address field for accessing the label index table.

2. The ingress node of claim 1, wherein the packet processor adds MPLS label information looked up from the label table to a header of the packet, and transmits the resultant packet through an output port.

3. The ingress node of claim 2, wherein the label index table comprises a field storing a hash value of a destination MAC address for accessing the label table, and
the packet processor searches for the label index table with reference to a label index table address field of the VLAN table, acquires the MPLS label information from a label table having an index corresponding to a hash value of a destination MAC address for accessing the label table in the searched label index table, with reference to the field storing the hash value of the destination MAC address, and adds the acquired label table to the header of the packet.

4. The ingress node of claim 3, wherein, if a VLAN ID is included in the packet, the packet processor determines the VLAN ID as a VLAN ID, and if no VLAN ID is included in the packet, the packet processor determines as a VLAN ID a default VLAN ID set in an L2 port table corresponding to an input port.

5. The ingress node of claim 3 or 4, wherein the packet processor searches for a VLAN table corresponding to a VLAN ID, acquires an output port ID and a line card number from a forwarding database table linked to the VLAN table, and acquires output port information from an L2 port table liked to a VLAN port table corresponding to the output port ID and the line card number.

6. The ingress node of claim 5, wherein the packet processor acquires the output port ID and the line card number from a forwarding entry table corresponding to a hash value of a MAC address stored in a forwarding entry table field of the forwarding database table.

7. The ingress node of claim 6, wherein the packet processor searches for a VLAN port table corresponding to the VLAN ID and a hash value of an output port ID acquired from the forwarding entry table, and acquires output port information from an L2 port table linked to the VLAN port table.

8. An egress node of a Multi-Protocol Label Switching (MPLS) network, comprising:
an incoming label map (ILM) table storing information for processing a MPLS label, and address information of a Virtual Local Area Network (VLAN) table;
an ILM index table in which each ILM table is stored as an index value corresponding to the MPLS label; and
a packet processor searching for an ILM table corresponding to a MPLS label included in the received packet from the ILM index table, searching for an output port using a VLAN table corresponding to VLAN table address information included in the searched ILM table, removing MPLS label information from the received packet, and outputting the resultant packet through the output port.

9. The egress node of claim 8, wherein the packet processor searches for a VLAN table corresponding to a VLAN ID, acquires an output port ID and a line card number from a forwarding database table linked to the VLAN table, and acquires output port information from an L2 port table linked to a VLAN port table corresponding to the output port ID and the line card number.

10. The egress node of claim 9, wherein the packet processor acquires the output port ID and the line card number, from a forwarding entry table corresponding to a hash value of a MAC address stored in a forwarding entry table field of the forwarding database table.

11. The egress node of claim 10, wherein the packet processor searches for a VLAN port table corresponding to the VLAN ID and a hash value of the output port ID acquired from the forwarding entry table, and acquires the output port information from the L2 port table linked to the VLAN port table.

12. The egress node of claim 9, wherein the packet processor reads a tagging field value from the VLAN port table, removes or adds a VLAN tag from or to the packet according to the tagging field value, and then outputs the resultant packet.

13. A method of improving a packet transfer rate in an ingress node, comprising:
searching for a Virtual Local Area Network (VLAN) table corresponding to a VLAN ID;
searching for a label table mapped to the VLAN table and storing Multi-Protocol Label switching (MPLS) label information for each destination MAC address, from a label index table;
adding MPLS label information looked up from the searched label table, to a header of an output packet; and
outputting the packet with the header including the MPLS label information to an output port.

14. The method of claim 13, wherein the searching of the VLAN table comprises determining as the VLAN ID a VLAN ID included in the packet if the VLAN ID is included in an input packet, and determining as the VLAN ID a default VLAN ID set in an L2 port table corresponding to an input port if no VLAN ID is included in the input packet.

15. A method of improving a packet transfer rate in an egress node, comprising:
searching in an ILM index table for an Incoming Label Map (ILM) table corresponding to a MPLS label acquired from MPLS label information of a received packet;
searching for an output port, using a VLAN table corresponding to a VLAN table address acquired from the searched ILM table; and
removing MPLS label information from the received packet and outputting the resultant packet through the searched output port.

16. The method of claim 15, wherein the removing of the MPLS label information from the received packet comprises reading a tagging field value from the VLAN port table, and removing or adding a VLAN tag from or to the received packet according to the tagging field value, and outputting the resultant packet through the output port.
